(19) United States
(12) Patent Application Publication
(10) Pub. No.: US 2021/0006656 A1
(43) Pub. Date: Jan. 7, 2021

(54) CONTACT-CENTER MOBILE VIRTUAL NETWORK OPERATOR

(71) Applicant: Talkdesk, Inc., San Francisco, CA (US)

(72) Inventors: Rui Gramacho, Lisbon (PT); Tiago Paiva, San Francisco, CA (US)

(21) Appl. No.: 16/669,656

(22) Filed: Oct. 31, 2019

Related U.S. Application Data
(60) Provisional application No. 62/908,574, filed on Sep. 30, 2019.
(60) Provisional application No. 62/870,913, filed on Jul. 5, 2019.

(51) Int. Cl. H04M 3/51; H04M 1/725; G10L 15/22; G10L 15/18; H04W 12/06; G06F 16/33

(52) U.S. Cl. CPC H04M 3/5133; H04M 3/5183; H04M 1/72525; G06F 3/0484; G10L 15/1822; H04W 12/06; G06F 16/334; G10L 15/22

(57) ABSTRACT

Disclosed herein are cloud-based contact center solutions configured as a mobile virtual network operator (MVNO) that can provide mobile subscription and call services and applications to contact center agents over a third-party communication system. Also disclosed are networking devices that communicates with the mobile virtual network operator.

### RELATED APPLICATION

This application claims priority to, and the benefit of, U.S. Provisional Patent Application No. 62/908,574, filed Sep. 30, 2019, entitled “System and Method for Contact-Center Mobile Virtual Network Operation,” which is incorporated by reference herein in its entirety.

### BACKGROUND

Today's contact centers are primarily on-premise software solutions. Using on-premise software, agents and supervisors use dedicated communication channels (e.g., telephones) that are configured with customized applications, middle-ware and software and are stationed in an on-site call center. Maintenance and upgrades of customized applications, middle-ware and software add requirements and cost to contact center applications.

There is a need for a solution to enhance the agent experience to enhance the interactions with customers who interact with contact centers.

### SUMMARY

Disclosed herein are systems and methods for providing a cloud-based contact center solution configured as a mobile virtual network operator (MVNO) that can provide mobile subscription and call services and applications to contact center agents over a third-party communication system (e.g., without the contact center having its own spectrum allocation). To this end, contact-center call services and applications may operate natively on a contact-center agent mobile device through the contact center MVNO service and native device applications with little, or no, user-end applications. The use of native mobile-device applications ensure that the agent mobile device can be maintained, managed, and upgraded from the back- and middle-end without need for network administrators of the contact center having to physically service the agent mobile device or the end-user application executed thereon. To this end, advanced or complex applications and services may be maintained/executed in the cloud-based contact center with minimal configuration to the respective mobile device that would use such applications and services.

Examples of contact center MVNO services and applications include, but are not limited to, agent automation services and analytics (e.g., through the use of artificial intelligence and the like). Automation services may include voice-to-text or speech-to-text conversion operations of a given data stream (e.g., voice or video data stream) to which the results, in some embodiments, are subjected to analysis performed by back-end cloud-based analytics services to provide potentially useful agent-assist information to an agent. In other embodiments, the results are used for workflow routing operations of that data stream.

As used herein, the term “agent” refers a person that is employed or contracted at the contact center to perform a function or service for a customer, who is also a person. The service or function provided may be related to services for new customers such as telemarketing, information gathering, or claim processing, as well as services for existing customer such as customer service, technical support, fraud prevention, and the like. The term “customer” as used herein also refers to a person.

As used herein, the term “agent mobile device” refers to a mobile device used by an agent in the context of contact center operations and workflow. Mobile device refers to a portable computing device such as a smartphone, mobile phone, portable computer, or tablet computer configured to operate in a broadband wireless network, mobile broadband network, LTE network, GSM network, CDMA network, 5G network, or the like. Mobile broadband generally refers to wireless Internet access through a built-in or external modem. Wireless broadband generally refers to high-speed wireless Internet access or computer networking access over a wide area.

In an aspect, a method is disclosed of configuring a mobile device to natively operate with a cloud-based contact center, the method comprising installing in the mobile device (e.g., smart phone) a subscriber identification module (SIM) associated with operation with a mobile network operator comprising a cloud-based contact center; authenticating via the mobile device the subscriber identification module with the mobile network operator comprising the cloud-based contact center; and natively routing from a network infrastructure at least a portion of a data transmission from an initiated data exchange between the mobile device and the mobile network operator comprising the cloud-based contact center, wherein the mobile network operator is configured to analyze the data transmission in one or more intelligent contact center applications.

In some embodiments, the method further includes converting, at the mobile network operator comprising the cloud-based contact center, a voice portion of the routed portion of data transmission to text data; and analyzing, at the mobile network operator comprising the cloud-based contact center, the text data to provide agent assist information in the intelligent contact center applications.

In some embodiments, the intelligent contact center applications is configured to extract smart notes from the text data real-time; and transmit the smart notes to the mobile device to be presented at a graphical user interface presented at the mobile device.

In some embodiments, the intelligent contact center applications are configured to search a database with the text data; and transmit retrieved information from the search to the mobile device to be presented at a graphical user interface presented at the mobile device.

In some embodiments, the subscriber identification module is configured to store an international mobile subscriber identity (IMSI) number and an associated authentication key.

In some embodiments, the mobile device is configured to natively route the portion of the data transmission from the initiated data exchange to the mobile network operator comprising the cloud-based contact center without an associated application (i.e., APP) associated with the mobile network operator comprising the cloud-based contact center executing on the mobile device.

In some embodiments, the mobile device is configured to natively route the portion of the data transmission from the initiated data exchange to the mobile network operator comprising the cloud-based contact center without direction or instructions from an associated application (i.e., APP) associated with the mobile network operator comprising the cloud-based contact center executing on the mobile device.

In some embodiments, the mobile device comprise a GSM phone, a CDMA phone, an LTE phone, or a 5G phone.

In some embodiments, the mobile device is configured to execute an Android operating system or an iOS operating system.

In some embodiments, the mobile device comprises a laptop or a tablet.

In another aspect, a method is disclosed of operating a cloud-based contact center, the method comprising: receiving, from a mobile device (e.g., smart phone) having a subscriber identification module (SIM), a request to join a mobile network operator comprising a cloud-based contact center; authenticating the mobile device using data from the subscriber identification module; and routing a data transmission from an initiated data exchange between the mobile device and the mobile network operator comprising the cloud-based contact center to one or more intelligent contact center application.

In some embodiments, the method further includes converting, at the mobile network operator comprising the cloud-based contact center, a voice portion of the routed portion of data transmission to text data; and analyzing, at the mobile network operator comprising the cloud-based contact center, the text data to provide agent assist information in the intelligent contact center applications.

In some embodiments, the intelligent contact center applications comprise an application configured to extract smart notes from the text data real-time; and transmit the smart notes to the mobile device to be presented at a graphical user interface presented at the mobile device.

In some embodiments, the intelligent contact center applications comprise an application configured to search a database with the text data; and transmit retrieved information from the search to the mobile device to be presented at a graphical user interface presented at the mobile device.

In some embodiments, the subscriber identification module is configured to store an international mobile subscriber identity (IMSI) number and an associated authentication key.

In some embodiments, the mobile device is configured to natively route the portion of the data transmission from the initiated data exchange to the mobile network operator comprising the cloud-based contact center without an associated application (i.e., APP) associated with the mobile network operator comprising the cloud-based contact center executing on the mobile device.

In some embodiments, the mobile device is configured to natively route the portion of the data transmission from the initiated data exchange to the mobile network operator comprising the cloud-based contact center without direction or instructions from an associated application (i.e., APP) associated with the mobile network operator comprising the cloud-based contact center executing on the mobile device.

In some embodiments, the mobile device comprise a GSM phone, a CDMA phone, an LTE phone, or a 5G phone.

In some embodiments, the mobile device comprise a laptop or a tablet.

In some embodiments, the mobile device is configured to execute an Android operating system or an iOS operating system.

In another aspect, an apparatus is disclosed comprising a mobile device (e.g., smart phone) comprising a processor and memory, the memory having instructions stored thereon; and a subscriber identification module, the subscriber identification module being configured with an identifier associated with a mobile network operator comprising the cloud-based contact center, wherein execution of the instructions by the processor, cause the processor to authenticate with the mobile network operator comprising the cloud-based contact center; and natively route at least a portion of data transmission from an initiated data exchange between the mobile device and the mobile network operator comprising the cloud-based contact center, wherein the mobile network operator is configured to analyze the data transmission for one or more intelligent contact center applications.

In some embodiments, the mobile network operator comprising the cloud-based contact center is configured to i) process a voice portion of the routed portion of data transmission and convert the voice portion to text data and ii) analyze the text data to provide agent assist information in the intelligent contact center applications.

In some embodiments, the intelligent contact center applications comprises a first application configured to extract smart notes from the text data real-time and transmit the smart notes to the apparatus to be presented at a graphical user interface of the apparatus.

In some embodiments, the intelligent contact center applications comprises a second application configured to search a database with the text data and transmit retrieved information from the search to the apparatus to be presented at a graphical user interface of the apparatus.

In some embodiments, the subscriber identification module is configured to store an international mobile subscriber identity (IMSI) number and an associated authentication key.

In some embodiments, the apparatus is configured to natively route the portion of the data transmission from the initiated data exchange to the mobile network operator comprising the cloud-based contact center without direction or instructions from an associated application (i.e., mobile APP) associated with the apparatus.

In some embodiments, the apparatus is configured to natively route the portion of the data transmission from the initiated data exchange to the mobile network operator comprising the cloud-based contact center without an associated application (i.e., APP) associated with the mobile network operator comprising the cloud-based contact center executing on the apparatus.

In some embodiments, the apparatus comprises a GSM phone, a CDMA phone, an LTE phone, or a 5G phone.

In some embodiments, the apparatus is configured to execute an Android operating system or an iOS operating system.

In some embodiments, the apparatus comprises a laptop or a tablet.

In another aspect, a cloud-based contact center configured as a mobile network operator is disclosed, the cloud-based contact center comprising a plurality of servers, including a first set of servers and a second set of servers, wherein the first set of servers include instructions that when executed by a processor cause the first set of servers to authenticate a plurality of mobile devices each configured with a subscriber identification module; and wherein the second set of servers include instructions that when executed by a processor cause the second set of servers to receive a plurality of data transmissions from initiated data exchanges between the plurality of mobile devices and a second set of communication devices, wherein the plurality of data transmissions from initiated data exchanges are each natively routed from the plurality of the mobile devices to the second set of servers for analysis without direction or instructions from a software application executing on a given mobile device of the plurality of mobile devices.

In some embodiments, the instructions that when executed by the processor of the respective first or second sets of servers cause the respective first or second sets of servers to process a voice portion of the routed portion of data transmission and convert the voice portion to text data; and analyze the text data to provide agent assist information in the intelligent contact center applications.

In some embodiments, the intelligent contact center applications comprises a first application configured to extract smart notes from the text data real-time and transmit the smart notes to the mobile device to be presented at a graphical user interface of the mobile device.

In some embodiments, the intelligent contact center applications comprises a second application configured to search a database with the text data and transmit retrieved information from the search to the mobile device to be presented at a graphical user interface of the mobile device.

In some embodiments, the subscriber identification module is configured to store an international mobile subscriber identity (IMSI) number and an associated authentication key.

In some embodiments, the mobile devices are configured to natively route the portion of the data transmission from the initiated data exchange to the mobile network operator comprising the cloud-based contact center.

In some embodiments, the mobile devices are configured to route the portion of the data transmission from the initiated data exchange to the mobile network operator comprising the cloud-based contact center using an associated application (i.e., mobile APP) executing on the respective mobile device.

In some embodiments, the mobile devices comprise a GSM phone, a CDMA phone, an LTE phone, or a 5G phone.

In some embodiments, the mobile devices are configured to execute an Android operating system or an iOS operating system.

In some embodiments, the mobile devices comprise a laptop or tablet.

In another aspect, a non-transitory computer readable medium is disclosed comprising instructions stored thereon, wherein execution of the instructions by a processor cause the processor to authenticate a mobile device comprising subscriber identification module, the subscriber identification module being configured with an identifier associated with a mobile network operator comprising a cloud-based contact center; and natively route at least a portion of data transmission from an initiated data exchange between the mobile device and the mobile network operator comprising the cloud-based contact center, wherein the mobile network operator is configured to analyze the data transmission for one or more intelligent contact center applications.

In some embodiments, the mobile network operator comprising the cloud-based contact center is configured to i) process a voice portion of the routed portion of data transmission and convert the voice portion to text data and ii) analyze the text data to provide agent assist information in the intelligent contact center applications.

In some embodiments, the intelligent contact center applications comprise a first application configured to extract smart notes from the text data real-time and transmit the smart notes to the mobile device to be presented at a graphical user interface of the mobile device.

In some embodiments, the intelligent contact center applications comprise a second application configured to search a database with the text data and transmit retrieved information from the search to the apparatus to be presented at a graphical user interface of the apparatus.

In some embodiments, the subscriber identification module is configured to store an international mobile subscriber identity (IMSI) number and an associated authentication key.

In some embodiments, the mobile device is configured to natively route the portion of the data transmission from the initiated data exchange to the mobile network operator comprising the cloud-based contact center without direction or instructions from an associated application (i.e., mobile APP) associated with the mobile device.

In some embodiments, the mobile device is configured to natively route the portion of the data transmission from the initiated data exchange to the mobile network operator comprising the cloud-based contact center without an associated application (i.e., APP) associated with the mobile network operator comprising the cloud-based contact center executing on the apparatus.

In some embodiments, the mobile device comprise a GSM phone, a CDMA phone, an LTE phone, or a 5G phone.

In some embodiments, the mobile device is configured to execute an Android operating system or an iOS operating system.

In some embodiments, the mobile device comprise a laptop or a tablet.

In another a non-transitory computer readable medium is disclosed comprising instructions stored thereon, wherein execution of the instructions by a processor of a computing device (e.g., mobile phone, laptop) cause the processor to retrieve data from a subscriber identification module; transmit the data to a mobile network operator comprising a cloud-based contact center; and receive acknowledgement and access to a network of the mobile network operator comprising the cloud-based contact center, wherein data exchange initiated between the computing device and the mobile network operator comprising the cloud-based contact center are natively routed to the mobile network operator, and wherein the mobile network operator is configured to analyze the data in the transmission using one or more intelligent contact center applications.

In some embodiments, the mobile network operator comprising the cloud-based contact center is configured to: process a voice portion of the routed portion of data transmission and convert the voice portion to text data; and analyze the text data to provide agent assist information in the intelligent contact center applications.

In some embodiments, the intelligent contact center applications comprises a first application configured to extract smart notes from the text data real-time and transmit the smart notes to the apparatus to be presented at a graphical user interface of the computing device.

In some embodiments, the intelligent contact center applications comprises a second application configured to search a database with the text data and transmit retrieved information from the search to the apparatus to be presented at a graphical user interface of the computing device.

In some embodiments, the subscriber identification module is configured to store an international mobile subscriber identity (IMSI) number and an associated authentication key.

In some embodiments, the computing device is configured to natively route the portion of the data transmission from the initiated data exchange to the mobile network operator comprising the cloud-based contact center.

In some embodiments, the computing device is configured to route the portion of the data transmission from the initiated data exchange to the mobile network operator comprising the cloud-based contact center using an associated application (i.e., mobile APP) executing on the computing device.

In some embodiments, the computing device comprise a GSM phone, a CDMA phone, an LTE phone, or a 5G phone.

In some embodiments, the computing device comprise a laptop or a tablet.

In some embodiments, the mobile devices are configured to execute an Android operating system or an iOS operating system.

Other systems, methods, features and/or advantages will be or may become apparent to one with skill in the art upon examination of the following drawings and detailed description.

It is intended that all such additional systems, methods, features and/or advantages be included within this description and be protected by the accompanying claims.

### BRIEF DESCRIPTION OF THE DRAWINGS

The components in the drawings are not necessarily to scale relative to each other. Like reference numerals designate corresponding parts throughout the several views.

FIG. 1 illustrates an example environment;

FIG. 2 illustrates a contact center mobile virtual network operator;

FIG. 3 illustrates example component that provide automation, routing and/or omnichannel functionalities within the context of the environment of FIG. 1;

FIG. 4 shows an example operation of the contact-center MVNO;

FIGS. 5 and 6 illustrate an example unified interface showing aspects of the operation of automation tools executing at the MVNO;

FIG. 7 illustrates an example smart notes user interface;

FIGS. 8 and 9 illustrate an example automatic scheduling user interface; and

FIG. 10 illustrates an example computing device.

### DETAILED DESCRIPTION

Unless defined otherwise, all technical and scientific terms used herein have the same meaning as commonly understood by one of ordinary skill in the art. Methods and materials similar or equivalent to those described herein can be used in the practice or testing of the present disclosure. While implementations will be described within a cloud-based contact center, it will become evident to those skilled in the art that the implementations are not limited thereto.

The present disclosure is generally directed to a cloud-based contact center solution configured as a mobile virtual network operator (MVNO). The exemplary MVNO contact centers employ cloud-based infrastructure to quickly add new feature sets and channels. Further, as a MVNO, the feature sets can be extended to agent mobile devices in a seamless manner by leveraging and using native functions of the agent mobile device. In using native operations of the agent mobile device, performance of the feature set may be improved, e.g., with reduce latency and tighter integration of middleware and firmware operations. Maintenance and management of such features and channels are also reduced as the features rely on native operation of the agent mobile device (e.g., mitigating the need for user-end applications). Further, feature sets may be added to existing and deployed agent mobile device in the cloud environment without such feature upgrades necessitating a software upgrade or update at the agent mobile device, e.g., where existing input and output from and to the agent mobile device have been defined.

More generally, cloud-based contact centers can improve a contact center agent experience by leveraging application programming interfaces (APIs) and software development kits (SDKs) to allow the contact center to change in response to an enterprise's needs. In some embodiments, communications channels may be easily added as the APIs and SDKs enable adding channels, such as SMS/MMS, social media, web, etc.

Cloud-based contact centers also provide a platform that enables frequent updates. Yet another advantage of cloud-based contact centers is increased reliability, as cloud-based contact centers may be strategically and geographically distributed around the world to optimally route calls to reduce latency and provide the highest quality experience. As such, customers are connected to agents faster and more efficiently.

### Example Cloud-Based Contact Center Architecture

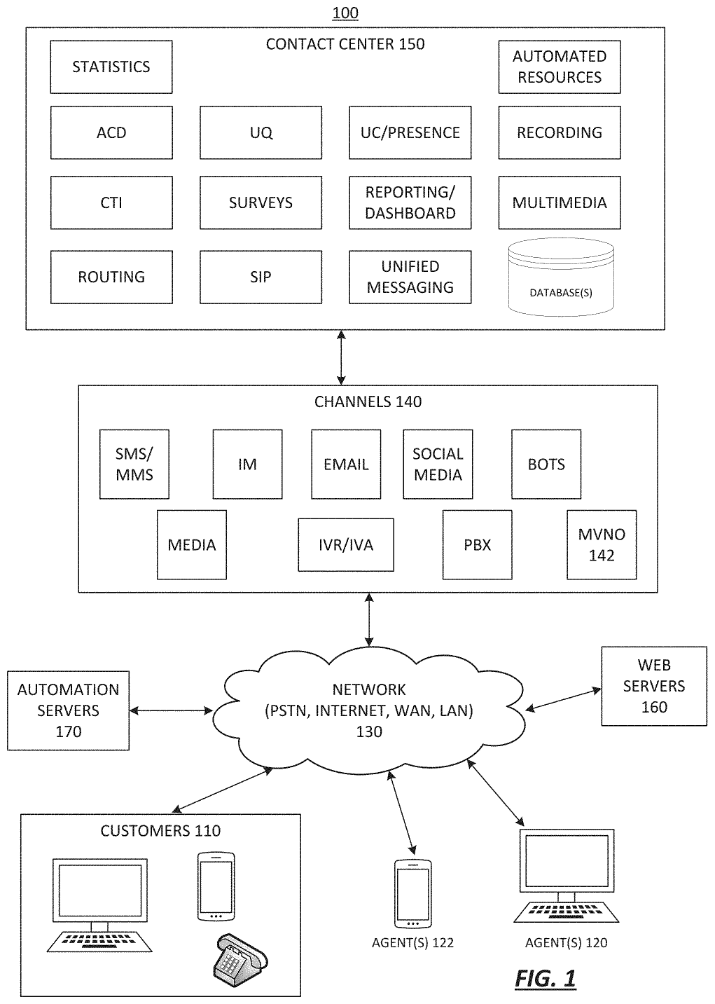

FIG. 1 is an example system 100, and illustrates example components, functional capabilities and optional modules that may be included in a cloud-based contact center MVNO.

Customers 110 interact with a contact center 150 using voice, email, text, and web interfaces in order to communicate with agent(s) 120 through a network 130 and one or more of text or multimedia channels 140. The agent(s) 120 may be remote from the contact center 150 and handle communications with customers 110 on behalf of an enterprise. The agent(s) 120 may utilize devices, such as but not limited to, work stations, desktop computers, laptops, telephones, a mobile smartphone and/or a tablet. Similarly, customers 110 may communicate using a plurality of devices, including but not limited to, a telephone, a mobile smartphone, a tablet, a laptop, a desktop computer, or other. For example, telephone communication may traverse networks such as a public switched telephone networks (PSTN), Voice over Internet Protocol (VoIP) telephony (via the Internet), a Wide Area Network (WAN) or a Large Area Network. The network types are provided by way of example and are not intended to limit types of networks used for communications.

The contact center 150 itself be in a single location or may be cloud-based and distributed over a plurality of locations. The contact center 150 may include servers, databases, and other components. In particular, the contact center 150 may include, but is not limited to, a routing server, a SIP server, an outbound server, a reporting/dashboard server, automated call distribution (ACD), a computer telephony integration server (CTI), an email server, an IM server, a social server, a SMS server, and one or more databases for routing, historical information and campaigns.

The reporting server may be configured to generate reports from data aggregated by the statistics server. Such reports may include, but are not limited to, near real-time reports or historical reports concerning the state of resources, such as, average waiting time, abandonment rate, agent occupancy, etc. The reports may be generated automatically or in response to specific requests from a requestor (e.g. agent/administrator, contact center application, etc.).

The routing server may serve as an adapter or interface between the switch and the remainder of the routing, monitoring, and other communication-handling components of the contact center. The routing server may be configured to process PSTN calls, VoIP calls, and the like. For example, the routing server may be configured with the CTI server software for interfacing with the switch/media gateway and contact center equipment. In other examples, the routing server may include the SIP server for processing SIP calls. The routing server may extract data about the customer interaction such as the caller's telephone number (often known as the automatic number identification (ANI) number), or the customer's internet protocol (IP) address, or email address, and communicate with other contact center components in processing the interaction.

The ACD is used by inbound, outbound and blended contact centers to manage the flow of interactions by routing and queuing them to the most appropriate agent. Within the CTI, software connects the ACD to a servicing application (e.g., customer service, CRM, sales, collections, etc.), and looks up or records information about the caller. CTI may display a customer's account information on the agent desktop when an interaction is delivered. Campaign management may be performed by an application to design, schedule, execute and manage outbound campaigns. Campaign management systems are also used to analyze campaign effectiveness.

For inbound SIP messages, the routing server may use statistical data from the statistics server and a routing database to the route SIP request message. A response may be sent to the media server directing it to route the interaction to a target agent 120. The routing database may include: customer relationship management (CRM) data; data pertaining to one or more social networks (including, but not limited to network graphs capturing social relationships within relevant social networks, or media updates made by members of relevant social networks); agent skills data; data extracted from third party data sources including cloud-based data sources such as CRM; or any other data that may be useful in making routing decisions.

Customers 110 may initiate inbound communications (e.g., telephony calls, emails, chats, video chats, social media posts, etc.) to the contact center 150 via an end user device. End user devices may be a communication device, such as, a telephone, wireless phone, smart phone, personal computer, electronic tablet, etc., to name some non-limiting examples. Customers 110 operating the end user devices may initiate, manage, and respond to telephone calls, emails, chats, text messaging, web-browsing sessions, and other multi-media transactions. Agent(s) 120 and customers 110 may communicate with each other and with other services over the network 130. For example, a customer calling on telephone handset may connect through the PSTN and terminate on a private branch exchange (PBX). A video call originating from a tablet may connect through the network 130 terminate on the media server. The channels 140 are coupled to the communications network 130 for receiving and transmitting telephony calls between customers 110 and the contact center 150. A media gateway may include a telephony switch or communication switch for routing within the contact center. The switch may be a hardware switching system or a soft switch implemented via software. For example, the media gateway may communicate with an automatic call distributor (ACD), a private branch exchange (PBX), an IP-based software switch and/or other switch to receive Internet-based interactions and/or telephone network-based interactions from a customer 110 and route those interactions to an agent 120. More detail of these interactions is provided below.

As another example, a customer smartphone may connect via the WAN and terminate on an interactive voice response (IVR)/intelligent virtual agent (IVA) components. IVR are self-service voice tools that automate the handling of incoming and outgoing calls. Advanced IVRs use speech recognition technology to enable customers 110 to interact with them by speaking instead of pushing buttons on their phones. IVR applications may be used to collect data, schedule callbacks and transfer calls to live agents. IVA systems are more advanced and utilize artificial intelligence (AI), machine learning (ML), advanced speech technologies (e.g., natural language understanding (NLU)/natural language processing (NLP)/natural language generation (NLG)) to simulate live and unstructured cognitive conversations for voice, text and digital interactions. IVA systems may cover a variety of media channels in addition to voice, including, but not limited to social media, email, SMS/MMS, IM, etc. and they may communicate with their counterpart's application (not shown) within the contact center 150.. The IVA system may be configured with a script for querying customers on their needs. The IVA system may ask an open-ended questions such as, for example, “How can I help you?” and the customer 110 may speak or otherwise enter a reason for contacting the contact center 150. The customer's response may then be used by a routing server to route the call or communication to an appropriate contact center resource.

In response, the routing server may find an appropriate agent 120 or automated resource to which an inbound customer communication is to be routed, for example, based on a routing strategy employed by the routing server, and further based on information about agent availability, skills, and other routing parameters provided, for example, by the statistics server. The routing server may query one or more databases, such as a customer database, which stores information about existing clients, such as contact information, service level agreement requirements, nature of previous customer contacts and actions taken by contact center to resolve any customer issues, etc. The routing server may query the customer information from the customer database via an ANI or any other information collected by the IVA system.

Once an appropriate agent and/or automated resource is identified as being available to handle a communication, a connection may be made between the customer 110 and an agent device of the identified agent 120 and/or the automate resource. Collected information about the customer and/or the customer's historical information may also be provided to the agent device for aiding the agent in better servicing the communication. In this regard, each agent device may include a telephone adapted for regular telephone calls, VoIP calls, etc. The agent device may also include a computer for communicating with one or more servers of the contact center and performing data processing associated with contact center operations, and for interfacing with customers via voice and other multimedia communication mechanisms.

The contact center 150 may also include a multimedia/social media server for engaging in media interactions other than voice interactions with the end user devices and/or other web servers 160. The media interactions may be related, for example, to email, vmail (voice mail through email), chat, video, text-messaging, web, social media, co-browsing, etc. In this regard, the multimedia/social media server may take the form of any IP router conventional in the art with specialized hardware and software for receiving, processing, and forwarding multi-media events.

The web servers 160 may include, for example, social media sites, such as, Facebook, Twitter, Instagram, etc. In this regard, the web servers 160 may be provided by third parties and/or maintained outside of the contact center 160 that communicate with the contact center 150 over the network 130. The web servers 160 may also provide web pages for the enterprise that is being supported by the contact center 150. End users may browse the web pages and get information about the enterprise's products and services. The web pages may also provide a mechanism for contacting the contact center, via, for example, web chat, voice call, email, WebRTC, etc.

The integration of real-time and non-real-time communication services may be performed by unified communications (UC)/presence sever. Real-time communication services include Internet Protocol (IP) telephony, call control, instant messaging (IM)/chat, presence information, real-time video and data sharing. Non-real-time applications include voicemail, email, SMS and fax services. The communications services are delivered over a variety of communications devices, including IP phones, personal computers (PCs), smartphones and tablets. Presence provides real-time status information about the availability of each person in the network, as well as their preferred method of communication (e.g., phone, email, chat and video).

Recording applications may be used to capture and play back audio and screen interactions between customers and agents. Recording systems should capture everything that happens during interactions and what agents do on their desktops. Surveying tools may provide the ability to create and deploy post-interaction customer feedback surveys in voice and digital channels. Typically, the IVR/IVA development environment is leveraged for survey development and deployment rules. Reporting/dashboards are tools used to track and manage the performance of agents, teams, departments, systems and processes within the contact center. Reports are presented in narrative, graphical or tabular formats. Reports can be created on a historical or real-time basis, depending on the data collected by the contact center applications. Dashboards typically include widgets, gadgets, gauges, meters, switches, charts and graphs that allow role-based monitoring of agent, queue and contact center performance. Unified messaging (UM) applications include various messaging and communications media (voicemail, email, SMS, fax, video, etc.) stored in a common repository and accessed by users via multiple devices through a single unified interface.

The cloud-based contact center 150 may include a number of other components. For example, the cloud-based contact center 150 may provide for speech analytics (e.g., post-call and real-time) to capture, structure and analyze unstructured phone conversations to uncover the reasons why people call, and to allow a company to identify and address an issue while the caller is still on the line. Text analytics may be used to extract information from unstructured text-based data such as emails, chats, SMS, social media, etc., in order to structure it for further analysis or action. Robotic process automation (RPA) may leverage artificial intelligent (A1), machine learning, workflow and other technologies to automate the processing of repetitive tasks, initiate actions and communicate with other systems or employees. RPA emulates the processes performed by human workers and can be trained to adapt to changing conditions, anomalies and new situations. Desktop analytics (DA) may capture, track and analyze events on the agent desktop. Real-time guidance/next-best action (NBA) tools may give agents the right information at the right time to deliver a personalized experience to each customer.

Automation operations may be used to enhance the operation of the contact center 150. In one aspect, the automation operations may be implemented as an application running on a mobile device of a customer 110, one or more cloud computing devices (generally labeled automation servers connected to the end user device over the network 130), one or more servers running in the contact center 150 (e.g., automated resources), or combinations thereof.

### Contact Center MNVO Application

In an aspect, a mobile device (e.g., smart phone) is configured (i.e., installed) with a subscriber identification module (SIM) for a mobile network operator comprising a cloud-based contact center. Once authenticated, the mobile device is configured to receive and transmit data (including voice, video, and audio) through a network infrastructure of the mobile network operator.

The received and transmitted data (including voice, video, and audio), in some embodiments, may be processed for intelligent contact center applications within the network infrastructure or via a service infrastructure coupled to the network infrastructure so that the intelligent contact center applications can be off-loaded from the mobile device.

For example, mobile device operating systems, such as Android, have mobile device native APIs that facilitate recording and speech recognition from the mobile device. However, such operations entails using processing and communication resources of the mobile device to generate a second audio stream to be transmitted to a speech recognition service. This can be extremely costly as audio and data stream of interest are now generated and pushed from the mobile device to another service infrastructure.

To improve the operation of such intelligent contact center applications, recording and speech recognition operations are performed at the network infrastructure or via a service infrastructure coupled to the network infrastructure. That is, during a telephony session through the network infrastructure, the telephony associated data stream are directed to a service associated module in the network infrastructure or are directed to a set of servers associated with the service infrastructure. This operation provides a data, audio, or video stream that is transacting with the mobile device without having to route it separately through the mobile device. Once captured via the service associated module in the network infrastructure or the set of servers associated with the service infrastructure, the data, audio, and/or video stream may be processed to through the intelligent contact center applications executing on the service infrastructure.

As noted above, the cloud-based contact center 150 (which may execute intelligent contact center applications) may include a number of other components (also referred to herein as intelligent contact center applications), e.g., for speech analytics (e.g., post-call and real-time) to capture, structure and analyze unstructured phone conversations to uncover the reasons why people call, and to allow a company to identify and address an issue while the caller is still on the line; text analytics, e.g., to extract information from unstructured text-based data such as emails, chats, SMS, social media, etc., in order to structure it for further analysis or action; robotic process automation (RPA) to leverage artificial intelligent (A1), machine learning, workflow and other technologies to automate the processing of repetitive tasks, initiate actions and communicate with other systems or employees; real-time guidance/next-best action (NBA) tools, e.g., to give agents the right information at the right time to deliver a personalized experience to each customer. In some embodiments, automation operations may be used to enhance the operation of the contact center 150. In one aspect, the automation operations may be implemented as an application running on a mobile device of a customer 110, one or more cloud computing devices (generally labeled automation servers 170 connected to the end user device over the network 130), one or more servers running in the contact center 150 (e.g., automated resources), or combinations thereof.

Native GUI or visualization APIs of the mobile operating system may then be invoked to textual or graphical data from such analysis. To this end, aspects of the intelligent contact center applications executing on the mobile device may be maintained via native APIs of the mobile devices and maintenance associated with the mobile applications can be reduced.

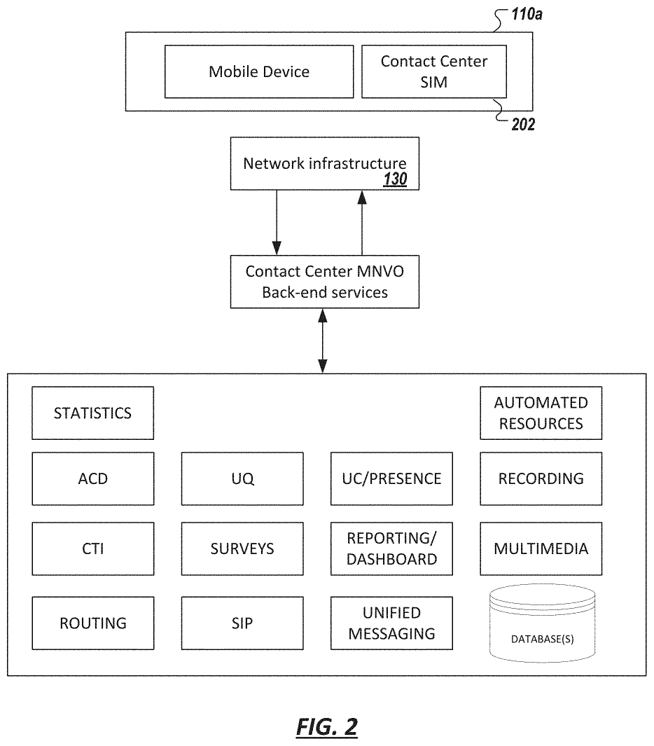

FIG. 2 illustrates a contact center mobile virtual network operator. Specifically, FIG. 2 shows an example network infrastructure (e.g., a GSM/GPRS network) that includes a core network and a GPRS network. The core network includes the mobile devices (shown as mobile device 110a), a number of base transceiver station (BTS) (i.e., radio tower), and a base station controller (BSC) (e.g., that manages radio resources).

The mobile device 110a has a unique identity defined by the International Mobile Equipment Identity Software Version (IMEI SV). The mobile device also includes a SIM card 202 that includes an IMEI SV. The SIM card 202 also has an identifier defined by the International Mobile Subscriber Identity (IMSI). The international mobile subscriber identity is a unique number that often comprises a 64-bit field and is sent by the mobile device to the network. For GSM, UMTS and LTE networks, the IMSI number is provisioned in the SIM card.

To this end, a subscriber may be identified by Mobile Station International Subscriber Directory Number (MSISDN); the SIM card 202 by the IMSI; and the mobile device 110a by the IMEI SV. The SIM card 202 may be distributed by the cloud-based contact center or a third-party distribution associated with, or contracting with, the cloud-based contact center.

The network infrastructure may also include a mobile switching center (MSC) (e.g., that provides interworking functionality with external networks, e.g., by performing the registration, authentication, location updating, handover, and call routing), a gateway mobile switching center (GMSC), a home location register (HLR), an authentication center, and a location register.

To gain access to GSM services such as speech, data, and short message service (SMS), the mobile device 110a may first register with the network to indicate its current location by performing a location update and IMSI attach procedure. The mobile device 110a may then send a location update including its current location information to the controller through the base transceiver station. The location information is then maintained in the network infrastructure and location update is periodically performed to update the database as location updating events occur.

The mobile device 110a may execute native mobile applications that are factory installed onto the mobile device, e.g., by the device's manufacturer or by the contact center MNVO. For example, native mobile applications may native intelligent contact center applications.

In addition, the mobile device 110a may be configured with native mobile applications such as a native web browser, such as, for example, Apple's Safari®, Google Android™ mobile web browser, Microsoft Internet Explorer® for Mobile, Opera Mobile™. The applications may be implemented as a series of machine-readable instructions for receiving, interpreting, and displaying web page information from remote servers while also receiving inputs from the user. Others native mobile applications may include a native texting or messaging application, a native email application, and a native dialer application via which a user is able to originate phone calls.

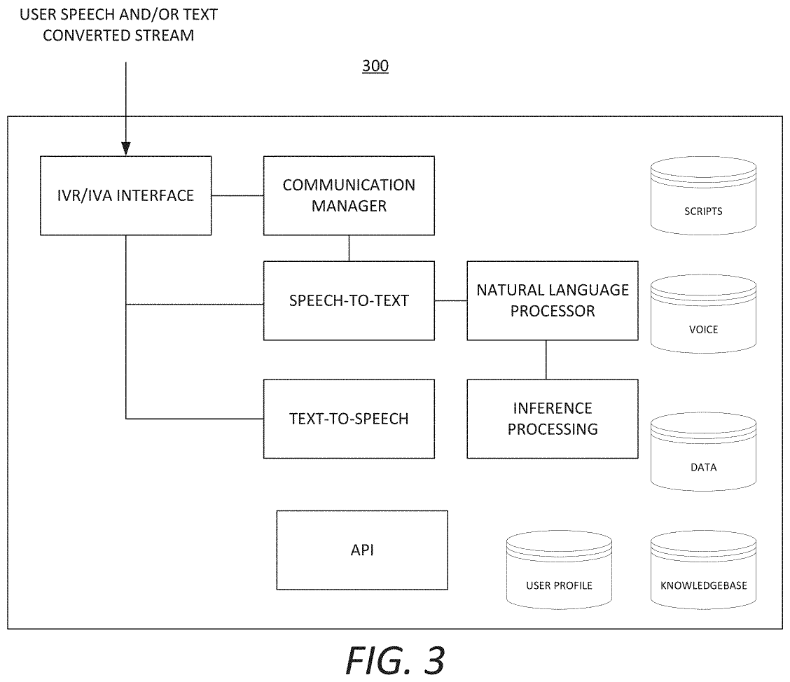

FIG. 3 illustrates an example automation application infrastructure 300 that may be implemented as the one or more automation servers and/or the server(s) within the cloud-based contact center 150. The automation infrastructure 200 may automatically collect information from a customer 110 user through the network infrastructure 130 where the collection of information does not require the involvement of a live agent.

The data collection may be provided as speech or text (e.g., unstructured, natural language input). This information may be used by the application 200 may be parsed by a natural language processing module to infer the speaker's (i.e., customer's intent) using an intent inference module in order to classify the intent. Where the collected data is speech, the speech is transcribed into text by a speech-to-text system (e.g., a large vocabulary continuous speech recognition or LVCSR system) as part of the parsing by the natural language processing module.

The intent inference module of the application in some embodiments is configured to automatically infer the customer's/speaker's intent from the converted text using artificial intelligence or machine learning techniques. These artificial intelligence techniques may include, for example, identifying one or more keywords from the converted text and searching a database of potential intents (e.g., call reasons) corresponding to the given keywords. The database of potential intents and the keywords corresponding to the intents may be automatically mined from a collection of historical interaction recordings, in which a customer may provide a statement of the issue, and in which the intent is explicitly encoded by an agent.

Some aspects of the present disclosure relate to the automatic authentication of the customer with the provider. For example, in some implementations, the user profile may include authentication information that would typically be requested of users accessing customer support systems such as usernames, account identifying information, personal identification information (e.g., a social security number), and/or answers to security questions. As additional examples, the application may have access to text messages and/or email messages sent to the customer's account on the end user device in order to access one-time passwords sent to the customer, and/or may have access to a one-time password (OTP) generator stored locally on the end user device. Accordingly, implementations of the present disclosure may be capable of automatically authenticating the customer with the contact center prior to an interaction.

In some implementations of the present disclosure an application programming interface (API) is used to interact with the provider directly. The provider may define a protocol for making commonplace requests to their systems. This API may be implemented over a variety of standard protocols such as Simple Object Access Protocol (SOAP) using Extensible Markup Language (XML), a Representational State Transfer (REST) API with messages formatted using XML or JavaScript Object Notation (JSON), and the like. Accordingly, a customer experience automation system 200 according to one implementation of the present disclosure automatically generates a formatted message in accordance with an API define by the provider, where the message contains the information specified by the script in appropriate portions of the formatted message.

Some aspects of the present disclosure relate to systems and methods for automating and augmenting aspects of an interaction between the customer 110 and a live agent of the contact center. In an implementation, once an interaction, such as through a phone call, has been initiated with the agent 120 (e.g., via the agent or via the customer), metadata regarding the conversation is displayed to the customer 110 and/or agent 120 in the UI throughout the interaction. Information, such as call metadata, may be presented to the customer 110 through the UI 205 on the customer's 110 mobile device 105. Examples of such information might include, but not be limited to, the provider, department call reason, agent name, and a photo of the agent.

According to some aspects of implementations of the present disclosure, both the customer 110 and the agent 120 can share relevant content with each other through the application (e.g., the application running on the end user device). The agent may share their screen with the customer 110 or push relevant material to the customer 110.

In yet another implementation, the application may also “listen” in on the conversation and automatically push relevant content from a knowledge-base to the customer 110 and/or agent 120. For example, the application may use a real-time transcription of the customer's speech (from converted speech to text) to query a knowledgebase to provide a solution to the agent 120. The agent may share a document describing the solution with the customer 110. The application may include several layers of intelligence where it gathers customer intelligence to learn everything it can about why the customer 110 is calling. Next, it may perform conversation intelligence, which is extracting more context about the customer's intent. Next, it may perform interaction intelligence to pull information from other sources about customer 100. The application 200 may also perform contact center intelligence to implement WFM/WFO (workflow management/workflow optimization) features of the contact center 150.

In yet another implementation, the application (e.g., Agent Assist application or engine) may analyze the conversation between the agent and the customer to create smart notes. This conversation could be a phone call, a text message, chat or video call, etc. Smart notes extracts the most relevant information from this conversation. For instance after a conversation, Agent Assist application may determine that the discussion between the agent 110 and the customer 120 was about “canceling an old order ” and “ placing a new order.” These would be extracted as Smart Notes and provide to the agent, who has an option to accept or modify the note. To achieve the above, Agent Assist application may separate the conversation between customer 110 and agent 120 to find words and phrases that are common between agents and customers, when a customer confirms a question, or when an agent confirms what customer says. For instance, the agent 120 may say, “Ok, so you would like to place a new order—correct?” In this case, the Smart Note would be a summary of the call about placing a new order.

In yet another implementation, the application (e.g., real-time analytics and error detection) is configured for real-time analytics and error detection by monitoring a conversation (i.e., a call, a text, an e-mail, video, chat, etc.) between the customer 110 and agent 120 in real-time to detect the following non-limiting categories: compliance (i.e., words that should not say in the conversation); competitors (i.e., if agent says the name of competitors); a set of “do's and don'ts” (e.g., words that agent should not say); if the agent is angry , curse etc.; if the agent is making fun of the caller; if the agent talks too fast, too slow, or if there is a delay between words; if the agent shows empathy; if the agent violates any policy; if the agent markets other products; if the agent talks about personal issues; if the agent is politically motivated; and/or if the agent promotes violence.

The process, in some embodiments, monitors the agent in real-time and expands upon the current state of the art, which is monitoring is at word level to monitor the transcript of the conversation and look for certain words or a variation of such words. For instance, if the agent is talking about pricing, the system may look for words such as “our pricing.” “our price list,” “do you want to know how much our product is,” etc. As another example, the agent may say “our product is beating everybody else,” which means the price is very affordable. Other examples such as these are possible.

In yet another implementation, the application (e.g., Artificial Intelligence (AI) Processing/Learning) is configured with a layer of deep learning that is used to create a large set of all potential of sentences and instances of the agent, including, e.g., said X and meant A; said Y and meant A; said Z but did not mean A; and/or said W and meant B. This sets may have several positive and negative examples around concepts, such as “cursing,” “being frustrated,” “rude attitude,” “too pushy for sale,” “soft attitude,” as well as word level examples, such as “shut up.” Deep learning does not need to extract features, rather deep learning, in some embodiments, is configured to take a set of sentences and classes (class is positive/negative, good bad, cursing/not cursing). Deep learning may learn and build a model out of all of these examples. For example, audio files of conversations recorded between agents 120 and customers 110 may be input to the deep learning module. Alternatively, transcribed words may be input to the deep learning module. Next, the system uses the learned model to listen to any conversation in real time and to identify the class such “cursing/not cursing.” As soon as the system identifies a class, and if it is negative or positive, it can do the following: send an alert to manager; make an indicator red on the screen; send a note to the agent to be reviewed in real-time or after the call; and/or update some data files for reporting and visualization. As part of the operation, natural language understanding operation may be used for intent spotting to determine intent, which may be used for IVR analysis and/or agent performance.

In this approach words are not important, rather the combination of all of words, the order of words and al potential variations of them have relevance. Deep learning 1002 considers all of the potential signals that could describe and hint toward a class. This approach is also language agnostic. It does not matter what language agent or caller speaks as long as there are a set of words and a set of classes, deep learning 1002 will learn and the model can be applied to the same language. In addition to the above, metadata may be added to every call, such as the time of the call, the duration of the call, the number of times the agent talked over the caller could be added to the data, etc.

In yet another implementation, the application (e.g., listening to other agents conversation in real-time) is configured to periodically classify conversations of other agents. The process may begin with the creation of a feature vector of a conversation. Such feature vector(s) includes but are not limited to: time of the call, duration of the call, topic of the call, frequency of words in the customer transcription (e.g. Ticket 2, Delay 4, etc.), frequency of words in the agent transcription (e.g. rebook 3, etc.), cluster conversations based on these features.

For the conversation happening in within a predetermined period (e.g., one month), the application may calculate the point wise mutual information between all of the calls in one cluster and make a graph of all calls in which the strength of the link is the weight of the point wise mutual information. Then, for the current file, the application may extract features, find the cluster, calculate the point wise mutual information, find the closest call to the current call, and/or show the content of the call to the agent.

In some embodiments, while the process analyzes calls, the application (e.g., Agent Assist) may learn and improve by analyzing user clicks. As relevant conversations are presented to the agent, if the agent clicks on a conversation and spends time on it, then it may mean that the conversation is relevant. Further, if the conversation is located, e.g., third on the list, but the agent clicks on the first conversation and moves forward, Agent Assist application may not make any assumptions about the conversation. Hence, the rank of the conversation may be of importance depending on the agent's actions. For the sake of simplicity, Agent Assist application may show the top three conversations to the agent. If some conversations ranked equally, Agent Assist application may pick one based on heuristics, for instance any conversation that has not been picked recently will be picked.

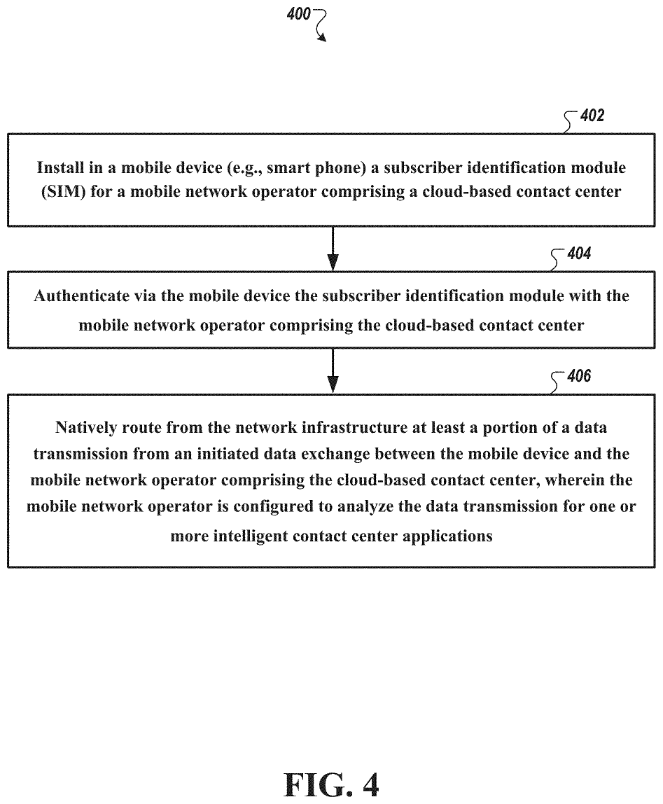

FIG. 4 shows an example operation of the contact-center MVNO. In FIG. 4, the operation 400 includes installing (step 402) in the mobile device (e.g., smart phone) a subscriber identification module (SIM) for a mobile network operator comprising a cloud-based contact center. The operation 400 includes authenticating (step 404) via the mobile device the subscriber identification module with the mobile network operator comprising the cloud-based contact center. The operation 400 includes natively routing (step 406) from the network infrastructure at least a portion of a data transmission from an initiated data exchange between the mobile device and the mobile network operator comprising the cloud-based contact center, wherein the mobile network operator is configured to analyze the data transmission for one or more intelligent contact center applications.

Natively routing operation generally refers to background services executing on a given device or within an infrastructure to which the device is connected that does not require the user of the a given user to have to install and/or service. In some embodiments, the native operation are executing the network to duplicate data/voice exchange associated with a given flow and routing the duplicated data/voice exchange to a set of modules executing in the network (e.g., cloud infrastructure) for analysis and/or automation operation. Thus, in the context of FIGS. 1-4, the present disclosure provides improvements by providing an innovative tool (also referred to herein as an Agent Assist tool) to reduce agent effort and improve customer experience quality through artificial intelligence using native functions of the network infrastructure.

The Agent Assist tool/application, in some embodiments, provides contact centers with an innovative tool designed to reduce agent effort, improve quality and reduce costs by minimizing search and data entry tasks The Agent Assist tool is natively built and fully unified within the agent interface (e.g., through native APIs of the mobile device operating system or through native APIs of the device itself) while keeping all data internally protected from third-party sharing.

Agent Assist application is a personalized conversational assistant that proactively supports frontline agents, ensuring customer experience excellence and minimal agent effort. Agent Assist provides contact centers with an innovative tool designed to reduce agent effort, improve quality and reduce costs by minimizing search and data entry tasks through the use of AI capabilities.

Agent Assist application is powered, in some embodiments, by artificial intelligence (AI) to provide real-time guidance for frontline employees to respond to customer needs quickly and accurately. As a customer 110 states their need, agents 120 are provided answers or supporting information immediately to expedite the conversation and simplify tasks. IVR assist makes recommendations to a supervisor to optimize IVR for a better customer experience. Agent Assist determines why customers are calling and what their intent is. Agent Assist helps optimize IVR questions to match customer's reasons for calling and what their intent is.

Agent Assist application intelligently positions information from a knowledge base, other agent, or CRM as a suggested action in real-time, contributing to a significant reduction in handle time and improving customer experience. Additionally, information captured within the agent interface can be automatically added to account profiles or work item tickets, within the CRM, without any additional agent effort. Agent Assist is an intelligent advisory tool which supplies data-driven real-time recommendations, next best actions and automations to aid agents in customer interactions and guide them to quality and outcome excellency. This may include making recommendations based on interactions, discussions and monitored KPIs. Agent Assist helps match agent skill to the reasons why customers are calling.

Agent Assist application simplifies agent effort and improves CSAT/NPS. Agent Assist reduces agent stress by eliminating search and browsing tasks, and proactively delivering information and next best actions in one simple interface. Agent Assist reduces manual supervision and assistance.

By leveraging automated assistance and reducing agent-supervisor ad-hoc interactions, Agent Assist gives supervisors more time to focus on workforce engagement activities. Agent Assist improves agent proficiency and accuracy. Agent Assist reduces short-and long-term training efforts through real-time error identification, eliminates busy work with smart note technology (the ability to systematically recognize and enter all key aspects of an interaction into the conversation notes); and improved handle time with in-app automations.

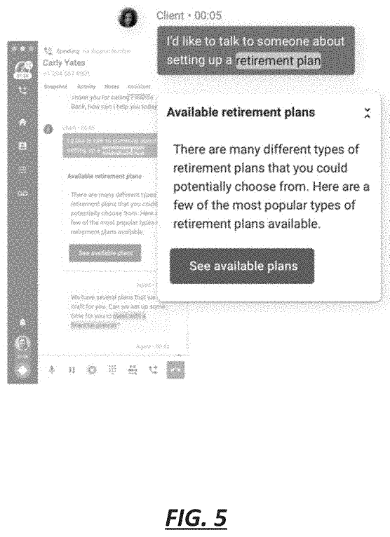

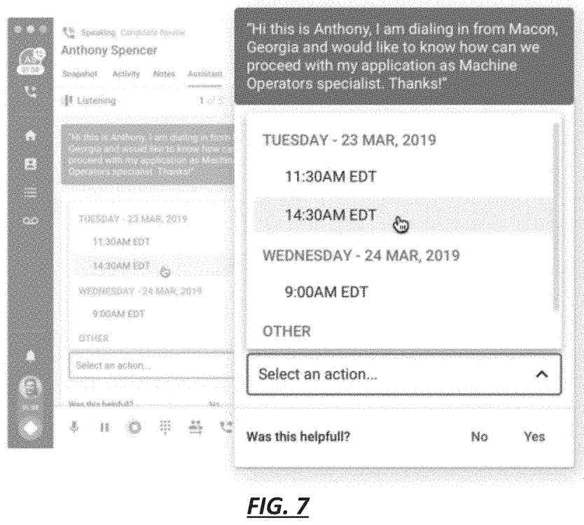

Agent Assist application, in some embodiments, is natively built and fully unified within the agent interface while keeping all data internally protected from third-party sharing. In combination with the cloud contact center 150, Agent Assist provides increased levels of customer service. Additional details are in FIGS. 5-10.

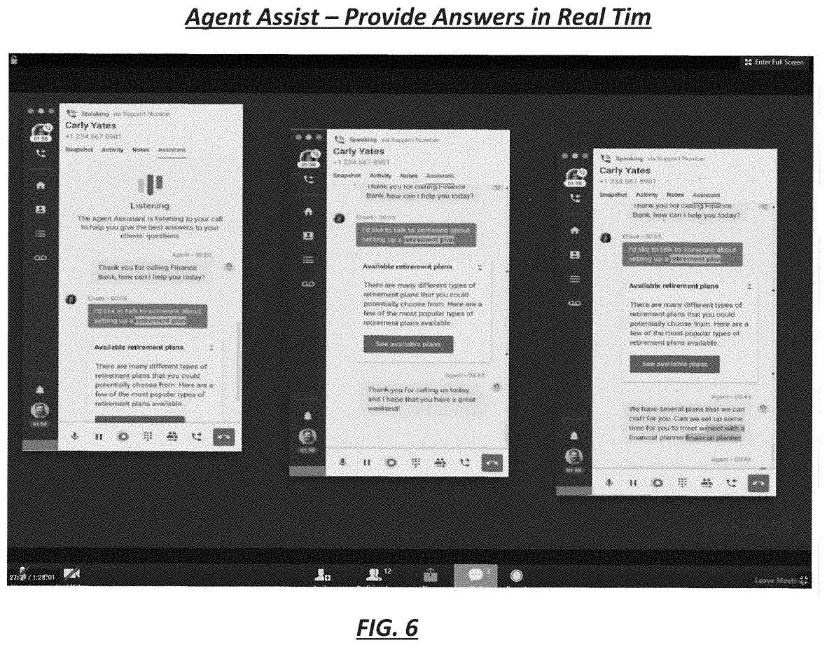

FIGS. 5 and 6 illustrate an example unified interface showing aspects of the operation of automation tools executing at the MVNO. In FIG. 5, the agent 120 is speaking on behalf of a financial institution. The agent 120 could be speaking on behalf of any entity for which the cloud-based contact center 150 serves. As shown in FIG. 5, the customer 110 is calling to ask questions about setting up a retirement plan. Because the context of the conversation is understood by the automation infrastructure to be related to a financial institution, Agent Assist application may identify that the term “retirement plan” is meaningful and highlights it to the agent.

The Agent Assist application may provide a prompt indicating to the agent 120 that there are many different types of retirement plans that the customer 110 can choose from. A button or other control is provided such that the agent 120 can click a link to see more information. The link to the information may provide text, audio, video, messages, tweets, posts, etc. to the agent 120. Agent Assist provides a segment and/or snippet in the text that is relevant to the customer's needs. In other implementations, Agent Assist provides a relevant interaction in the past (e.g., a similar call with a similar issue that agent 120 was able to address, etc.) or provide cross channel information (e.g., find a most relevant e-mail for a call, etc.).

Agent Assist application may provide an option to schedule a meeting or call between the customer 110 and a financial planner (i.e., a person with additional knowledge within the entity who may satisfy the customer's request to the agent 120). Examples of such GUI is provided in FIG. 6, which is provided herein as a non-limiting example.

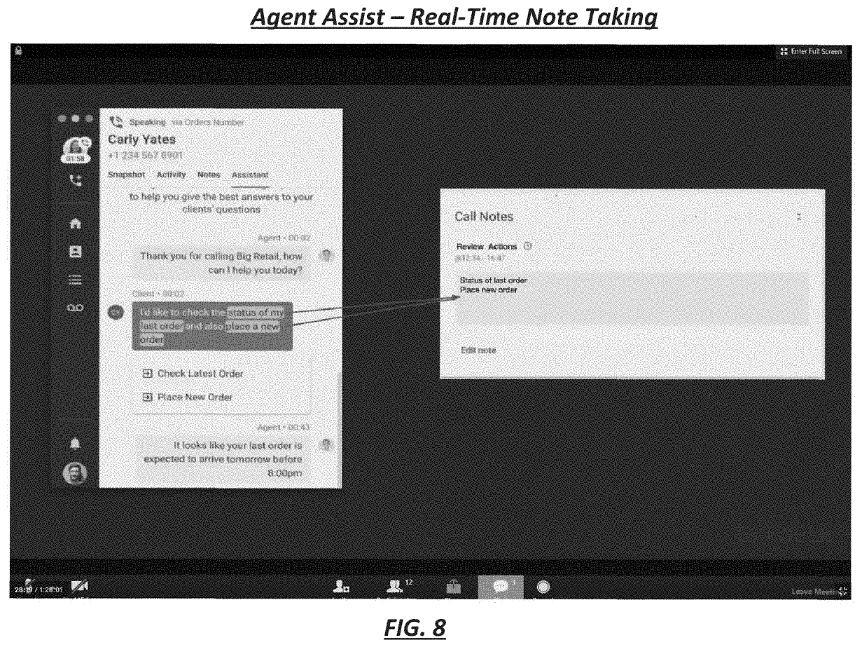

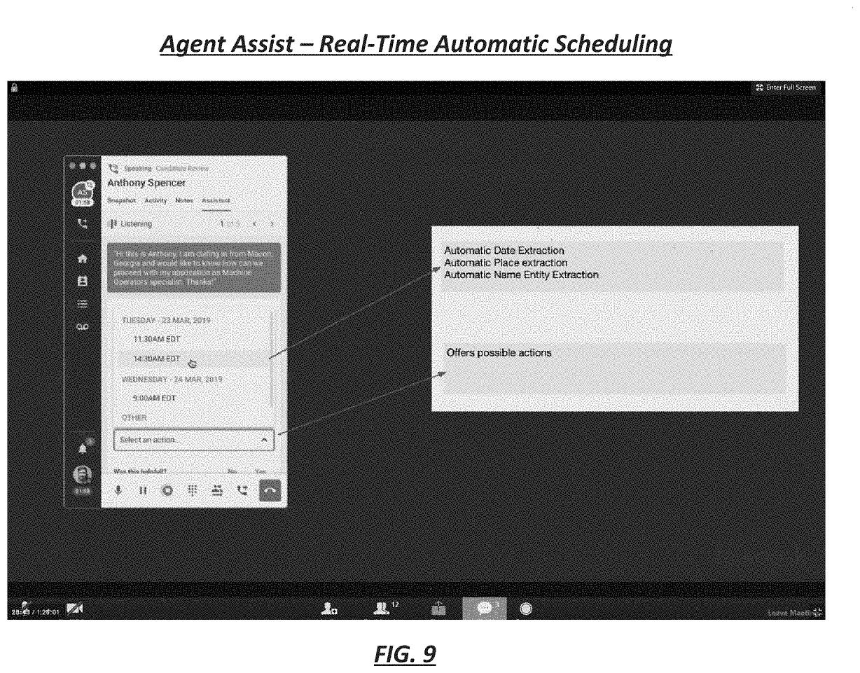

In yet another implementation, the application (e.g., Automatic data entry) is configured to, when Agent Assist application detects the participants in a conversation, automatically fill out any forms that pop-up after such conversations. In some embodiments, information is extracted to populate forms. As shown in FIGS. 8 and 9, in response to the customer indicating that he or she is calling to move forward on a job application, scheduling information may be presented to the agent in a field. This information may populate into user interface field together with additional information in field to schedule the call for an interview with the appropriate person. In another example, if the person says, “Hi my name is John? I like to return my iPhone 6,” a form may pop up with some of the information such as Name: John and Phone: iPhone 6prefilled into the form.

Such automated data entry includes but not limited to, date, time, day of the week, first name, last name, gender, address, object description (e.g., Samsung Galaxy), type of the object (e.g. Galaxy S9), time of the day (e.g. morning, afternoon). After the information is populated, the process ends.

In another aspect, the subscription to the contact center MVNO may be managed with two billing events: one for the contact center service and associated data/voice use and a second for the data/voice used by the user. In some embodiments, automation tools and intent tools may be used, e.g., those discussed herein to infer whether a call is considered a contact center service and a call that is not. In some embodiments, the contact center routing tool may generate, when routing a customer call to the mobile device associated with an agent, an event or label designating a given call to the mobile device as a contact center service associated call. To this end, billing and subscription tracking of a given contact center service subscription may be compiled based on the such events and labels.

In some embodiments, the contact center MNVO may be configured to maintain “personal hunt group” or “personal ring group” in which a unified number from a customer may be used to trigger multiple voice instances: webphone (callbar like), deskphone (sip) and Mobile.

In some embodiments, mobile applications can be further installed on mobile devices and invoke function call of API(s) native to the mobile device operating system to augment the native applications discussed herein.

### General Purpose Computer Description

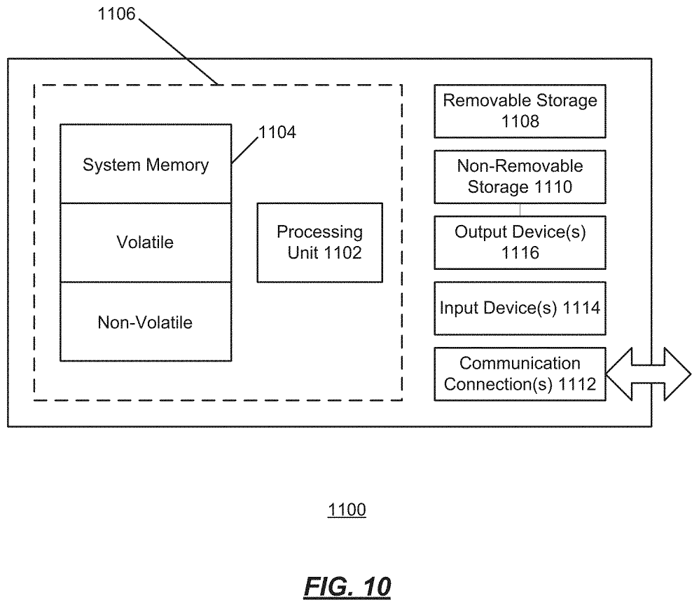

FIG. 10 shows an exemplary computing environment in which example embodiments and aspects may be implemented, e.g., of the mobile device (e.g., 110, 110a), among others. The computing system environment is only one example of a suitable computing environment and is not intended to suggest any limitation as to the scope of use or functionality.

Numerous other general purpose or special purpose computing system environments or configurations may be used. Examples of well-known computing systems, environments, and/or configurations that may be suitable for use include, but are not limited to, personal computers, servers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 1100. In its most basic configuration, computing device 1100 typically includes at least one processing unit 1102 and memory 1104. Depending on the exact configuration and type of computing device, memory 1104 may be volatile (such as random-access memory (RAM)), non-volatile (such as read-only memory (ROM), flash memory, etc.), or some combination of the two. This most basic configuration is illustrated in FIG. 10 by dashed line 1106.

Computing device 1100 may have additional features/functionality. For example, computing device 1100 may include additional storage (removable and/or non-removable) including, but not limited to, magnetic or optical disks or tape. Such additional storage is illustrated in FIG. 10 by removable storage 1108 and non-removable storage 1110.

Computing device 1100 typically includes a variety of tangible computer readable media. Computer readable media can be any available tangible media that can be accessed by device 1100 and includes both volatile and non-volatile media, removable and non-removable media.

Tangible computer storage media include volatile and non-volatile, and removable and non-removable media implemented in any method or technology for storage of information such as computer readable instructions, data structures, program modules or other data. Memory 1104, removable storage 1108, and non-removable storage 1110 are all examples of computer storage media. Tangible computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 1100. Any such computer storage media may be part of computing device 1100.

Computing device 1100 may contain communications connection(s) 1112 that allow the device to communicate with other devices. Computing device 1100 may also have input device(s) 1114 such as a keyboard, mouse, pen, voice input device, touch input device, etc. Output device(s) 1116 such as a display, speakers, printer, etc. may also be included. All these devices are well known in the art and need not be discussed at length here.

It should be understood that the various techniques described herein may be implemented in connection with hardware or software or, where appropriate, with a combination of both. Thus, the methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium wherein, when the program code is loaded into and executed by a machine, such as a computer, the machine becomes an apparatus for practicing the presently disclosed subject matter. In the case of program code execution on programmable computers, the computing device generally includes a processor, a storage medium readable by the processor (including volatile and non-volatile memory and/or storage elements), at least one input device, and at least one output device. One or more programs may implement or utilize the processes described in connection with the presently disclosed subject matter, e.g., through the use of an application programming interface (API), reusable controls, or the like. Such programs may be implemented in a high level procedural or object-oriented programming language to communicate with a computer system. However, the program(s) can be implemented in assembly or machine language, if desired. In any case, the language may be a compiled or interpreted language and it may be combined with hardware implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus for use by an agent of a cloud-based contact center to process customer calls, the apparatus comprising:
a mobile device for the agent comprising a processor and memory, the memory having instructions stored thereon; and
a subscriber identification module, the subscriber identification module being configured with an identifier associated with a mobile network operator comprising the cloud-based contact center,
wherein execution of the instructions by the processor, cause the processor to:
authenticate with the mobile network operator comprising the cloud-based contact center; and
natively route at least a portion of data transmission from an initiated data exchange between the mobile device and the mobile network operator comprising the cloud-based contact center, wherein the mobile network operator is configured to analyze the data transmission for one or more intelligent contact center applications.

2. The apparatus of claim 1, wherein the mobile network operator comprising the cloud-based contact center is configured to i) process a voice portion of the routed portion of data transmission and convert the voice portion to text data and ii) analyze the text data to provide agent assist information in the intelligent contact center applications.

3. The apparatus of claim 2, wherein at least one of the intelligent contact center applications is configured to extract smart notes from the text data real-time and transmit the smart notes to the apparatus to be presented at a graphical user interface of the apparatus.

4. The apparatus of claim 2, wherein at least one of the intelligent contact center applications is configured to search a database with the text data and transmit retrieved information from the search to the apparatus to be presented at a graphical user interface of the apparatus.

5. The apparatus of claim 1, wherein the subscriber identification module is configured to store an international mobile subscriber identity (IMSI) number and an associated authentication key.

6. The apparatus of claim 1, wherein the apparatus is configured to natively route the portion of the data transmission from the initiated data exchange to the mobile network operator comprising the cloud-based contact center without direction or instructions from an associated application associated with the apparatus.

7. The apparatus of claim 1, wherein the apparatus is configured to natively route the portion of the data transmission from the initiated data exchange to the mobile network operator comprising the cloud-based contact center without an associated application associated with the mobile network operator comprising the cloud-based contact center executing on the apparatus.

8. The apparatus of claim 1, wherein the apparatus comprises a GSM phone, a CDMA phone, an LTE phone, or a 5G phone.

9. The apparatus of claim 1, wherein the apparatus is configured to execute an Android operating system or an iOS operating system.

10. The apparatus of claim 1, wherein the apparatus comprises a laptop or a tablet.

11. A cloud-based contact center configured as a mobile network operator for use by a plurality of agents of the cloud-based contact center using a plurality of mobile devices to process customer calls, the cloud-based contact center comprising:
a plurality of servers, including a first set of servers and a second set of servers, wherein the first set of servers include instructions that when executed by a processor cause the first set of servers to authenticate the plurality of mobile devices each configured with a subscriber identification module; and
wherein the second set of servers include instructions that when executed by a processor cause the second set of servers to receive a plurality of data transmissions from initiated data exchanges between the plurality of mobile devices and a second set of communication devices, wherein the plurality of data transmissions from initiated data exchanges are each natively routed from the plurality of the mobile devices to the second set of servers for analysis without direction or instructions from a software application executing on a given mobile device of the plurality of mobile devices.

12. The cloud-based contact center of claim 11, wherein the instructions that when executed by the processor of the respective first or second sets of servers cause the respective first or second sets of servers to:
process a voice portion of the routed portion of data transmission and convert the voice portion to text data; and
analyze the text data to provide agent assist information in the intelligent contact center applications.

13. The cloud-based contact center of claim 12, wherein the intelligent contact center applications comprises a first application configured to extract smart notes from the text data real-time and transmit the smart notes to the mobile device to be presented at a graphical user interface of the mobile device.

14. The cloud-based contact center of claim 12, wherein the intelligent contact center applications comprises a second application configured to search a database with the text data and transmit retrieved information from the search to the mobile device to be presented at a graphical user interface of the mobile device.

15. The cloud-based contact center of claim 11, wherein the subscriber identification module is configured to store an international mobile subscriber identity (IMSI) number and an associated authentication key.

16. The cloud-based contact center of claim 11, wherein the mobile devices are configured to natively route the portion of the data transmission from the initiated data exchange to the mobile network operator comprising the cloud-based contact center.

17. The cloud-based contact center of claim 11, wherein the mobile devices are configured to route the portion of the data transmission from the initiated data exchange to the mobile network operator comprising the cloud-based contact center using an associated application executing on the respective mobile device.

18. The cloud-based contact center of claim 11, wherein the mobile devices comprise a GSM phone, a CDMA phone, an LTE phone, or a 5G phone.

19. The cloud-based contact center of claim 11, wherein the mobile devices are configured to execute an Android operating system or an iOS operating system.

20. The cloud-based contact center of claim 11, wherein the mobile devices comprise a laptop or tablet.
